(19) United States
(12) Patent Application Publication
(10) Pub. No.: US 2006/0237682 A1
(43) Pub. Date: Oct. 26, 2006

(54) Size composition

(76) Inventors: Thorsten Rische, Unna (DE); Gerald Kurek, Leipzig (DE); Jurgen Meixner, Krefeld (DE); Thomas Feller, Solingen (DE)

Correspondence Address: BAYER MATERIAL SCIENCE LLC, 100 BAYER ROAD, PITTSBURGH, PA, 15205, US

(21) Appl. No.: 11/405,249

(22) Filed: Apr. 17, 2006

(30) Foreign Application Priority Data
Apr. 22, 2005 (DE) 102005 018692.0

(51) Int. Cl. D06M 15/564; C08L 75/04; B32B 27/40

(52) U.S. Cl. 252/8.83; 525/457

(57) ABSTRACT

The invention provides hydrolysis-stable size compositions based on polycarbonate polyols and polytetramethylene glycol polyols, their preparation and use.

### CROSS-REFERENCE TO RELATED APPLICATION

This application claims priority under 35 U.S.C. §119 (a-e) to German application DE 102005 018692, filed Apr. 22, 2005.

### FIELD OF THE INVENTION

The invention relates to hydrolysis-stable size compositions based on polycarbonate polyols and polytetramethylene glycol polyols, their preparation and use.

### BACKGROUND OF THE INVENTION

In the sizing of glass fibres and carbon fibres use is made, as described for example in EP-A 792 900, of polyurethane-polyurea dispersions (PU dispersions) and crosslinkers as binder components in the size composition.

A disadvantage of the size compositions described to date in the prior art that are suitable for producing glass fibres or carbon fibres is in particular, owing to the profiles of requirements, which have increased, an inadequate resistance to hydrolysis and glycolysis.

DE-A 101 22 444 describes hydrolysis-stable, ionically and/or nonionically hydrophilicized polyurethane-polyurea (PU) dispersions based on polycarbonate polyols and polytetramethylene glycol polyols. On a very wide variety of substrates the dispersions, in one-component coating compositions, lead to coatings which are stable to hydrolysis and resistant to creasing and scratching. The use of these dispersions as a binder component in sizes, however, is not described.

It was therefore an object of the present invention to provide glass fibre sizes which take account of the profile of requirements referred to above, particularly as regards resistance to hydrolysis and to glycolysis.

### SUMMARY OF THE INVENTION

It has now been found that aqueous sizes comprising not only PU polymers based on polycarbonate polyols and polytetramethylene glycol polyols but also hydrophilic, water-dispersible or water-dispersed blocked polyisocyanates as crosslinkers exhibit excellent hydrolysis and glycolysis stability and at the same time the desired reinforcing properties of the sized glass and/or carbon fibres in the polymeric compound.

The present invention accordingly provides size compositions composed of
(I) one or more aqueous polyurethane-polyurea polymers (PU polymers) synthesized from compounds selected from the group containing
   I.1) polyisocyanates,
   I.2) mixture of polycarbonate polyols and polytetramethylene glycol polyols having number-average molecular weights of 200 to 8000 g/mol,
   I.3) compounds of molecular weight 62 to 400 possessing in total two or more hydroxyl and/or amino groups,
   I.4) compounds possessing a hydroxyl or amino group,
   I.5) isocyanate-reactive, ionically or potentially ionically hydrophilicizing compounds,
   I.6) isocyanate-reactive nonionically hydrophilicizing compounds, and
(II) water-dispersible, blocked polyisocyanates at least 50% of whose isocyanate groups are blocked,
(III) optionally further polymers soluble, emulsifiable or dispersible in water, and
(IV) auxiliaries and additives selected from the group of coupling agents, lubricants, antistats, dyes, pigments, flow control agents, light stabilizers, ageing inhibitors or UV absorbers.

A process for preparing the size composition is also provided, the process comprising the stepst of

### DETAILED DESCRIPTION OF PREFERRED EMBODIMENTS

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

Suitable polyisocyanates of component I.1) are the aromatic, araliphatic, aliphatic or cycloaliphatic polyisocyanates with an NCO functionality of preferably ≧2 which are known per se to the skilled person and which may also contain iminooxadiazinedione, isocyanurate, uretdione, urethane, allophanate, biuret, urea, oxadiazinetrione, oxazolidinone, acylurea and/or carbodiimide structures. They may be used individually or in any desired mixtures with one another.

Examples of suitable polyisocyanates are butylene diisocyanate, hexamethylene diisocyanate (HDI), isophorone diisocyanate (IPDI), 2,2,4 and/or 2,4,4-trimethylhexamethylene diisocyanate, the isomeric bis(4,4′-isocyanatocyclohexyl)methanes or their mixtures with any desired isomer content, isocyanatomethyloctane 1,8-diisocyanate, cyclohexylene 1,4-diisocyanate, phenylene 1,4-diisocyanate, tolylene 2,4- and/or 2,6-diisocyanate, naphthylene 1,5-diisocyanate, diphenylmethane 2,4′- or 4,4′-diisocyanate, triphenylmethane 4,4′,4″-triisocyanate or derivatives based on the aforementioned diisocyanates and having a uretdione, isocyanurate, urethane, allophanate, biuret, iminooxadiazinedione and/or oxadiazinetrione structure with more than 2 NCO groups, such as are described by way of example in J. Prakt. Chem. 336 (1994) pp. 185-200.

An example that may be mentioned of an unmodified polyisocyanate having more than 2 NCO groups per molecule is 4-isocyanatomethyloctane 1,8-diisocyanate (nonane triisocyanate).

The polyisocyanates or polyisocyanate mixtures in question are preferably those of the aforementioned kind containing exclusively aliphatically and/or cycloaliphatically attached isocyanate groups.

Particular preference is given to hexamethylene diisocyanate, isophorone diisocyanate, the isomeric bis(4,4′-isocyanatocyclohexyl)methanes and also mixtures thereof.

The PU polymers (I) comprise as component I.2) a mixture of polycarbonate polyols and polytetramethylene glycol polyols. The fraction of polycarbonate polyols in the mixture is between 20% and 80% by weight, the fraction of polytetramethylene glycol polyols between 80% and 20% by weight. Preference is given to a fraction of 30% to 75% by weight of polytetramethylene glycol polyols and to a fraction of 25% to 70% by weight of polycarbonate polyols. Particular preference is given to a fraction of 35% to 70% by weight of polytetramethylene glycol polyols and to a fraction of 30% to 65% by weight of polycarbonate polyols, in each case with the proviso that the sum of the weight percentages of the polycarbonate polyols and polytetramethylene glycol polyols makes 100%.

The polyols specified under I.2) have an OH functionality of at least I.8 to 4. It is preferred to use polyols in an average molar weight range from 200 to 8000 with an OH functionality of 2 to 3. Particularly preferred polyols have average molecular weight ranges from 200 to 3000.

Suitable polytetramethylene glycol polyols are polytetramethylene glycol polyethers, which can be prepared, for example, via polymerization of tetrahydrofuran by means of cationic ring opening.

Hydroxyl-containing polycarbonate polyols meeting the definition of component I.2) are obtainable by reacting carbonic acid derivatives, such as diphenyl carbonate, dimethyl carbonate or phosgene, with diols.

Examples of suitable such diols include ethylene glycol, 1,2- and 1,3-propanediol, 1,3- and 1,4-butanediol, 1,6-hexanediol, 1,8-octanediol, 1,12-dodecanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A or else lactone-modified diols. The diol component preferably contains 40% to 100% by weight of hexanediol, preferably 1,6-hexanediol and/or hexanediol derivatives, more preferably those derivatives which in addition to terminal OH groups contain ether groups or ester groups, such as products obtained by reacting 1 mol of hexanediol with at least 1 mol, preferably 1 to 2 mol, of caprolactone or by etherifying hexanediol with itself to form the di- or trihexylene glycol. The preparation of such derivatives is known for example from DE-A 15 70 540. The polyether-polycarbonate diols described in DE-A 37 17 060, as well, can be used.

The hydroxyl polycarbonates are preferably linear but may also be branched where appropriate as a result of the incorporation of polyfunctional components, especially low molecular weight polyols. Examples of those suitable for this purpose include glycerol, trimethylolpropane, hexane-1,2,6-triol, butane-1,2,4-triol, trimethylolpropane, pentaerythritol, quinitol, mannitol and sorbitol, methylglycoside and 1,3,4,6-dianhydrohexitols.

The low molecular weight polyols I.3) used for synthesizing the polyurethane resins generally have the effect of stiffening and/or branching the polymer chain. The molecular weight is situated preferably between 62 and 200. Suitable polyols may contain aliphatic, alicyclic or aromatic groups. Mention may be made here, by way of example, of the low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, hydroquinone dihydroxyethyl ether, bisphenol A (2,2-bis(4-hydroxyphenyl)propane), hydrogenated bisphenol A (2,2-bis(4-hydroxycyclohexyl)propane), and mixtures thereof, and also trimethylolpropane, glycerol or pentaerythritol. Ester diols as well, such as δ-hydroxybutyl-ε-hydroxycaproic ester, ω-hydroxyhexyl-γ-hydroxybutyric ester, adipic acid (β-hydroxyethyl) ester or terephthalic acid bis(β-hydroxyethyl)ester, can be used.

Diamines or polyamines and also hydrazides may likewise be employed as I.3), examples being ethylenediamine, 1,2- and 1,3-diaminopropane, 1,4-diaminobutane, 1,6-diaminohexane, isophoronediamine, isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic dihydrazide.

Also suitable in principle as I.3) are compounds which contain active hydrogen with different reactivity towards NCO groups, such as compounds which in addition to a primary amino group also contain secondary amino groups, or in addition to an amino group (primary or secondary) also contain OH groups. Examples of such are primary/secondary amines, such as 3-amino-1-methylaminopropane, 3-amino-1-ethylaminopropane, 3-amino-1-cyclohexylaminopropane, 3-amino-1-methylaminobutane, additionally alkanolamines such as N-aminoethylethanolamine, ethanolamine, 3-aminopropanol, neopentanolamine and, with particular preference, diethanolamine. In the case of use for preparing the PU dispersion (I) they are used as chain extenders, and in the case of use for preparing the PU dispersion (II) they are used for chain termination.

The polyurethane resin may also optionally include units I.4) which are located in each case at the chain ends and cap them. These units derive on the one hand from monofunctional compounds that are reactive with NCO groups, such as monoamines, especially mono-secondary amines, or monoalcohols. Examples that may be mentioned here include the following: ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, and/or suitable substituted derivatives thereof, amide amines of diprimary amines and monocarboxylic acids, monoketimes of diprimary amines, primary/tertiary amines, such as N,N-dimethylaminopropylamine and the like.

By ionically and potentially ionically hydrophilicizing compounds I.5) are meant all compounds which contain at least one isocyanate-reactive group and also at least one functionality, such as —COOY, —SO₃Y, —PO(OY)₂ (Y for example ═H, NH₄⁺, metal cation), —NR₂, —NR₃⁺ (R═H, alkyl, aryl), which on interaction with aqueous media enters into a pH-dependent dissociation equilibrium and in that way can have a negative, positive or neutral charge. Preferred isocyanate-reactive groups are hydroxyl or amino groups.

Suitable ionically or potentially ionically hydrophilicizing compounds making the definition of component I.5) are, for example, mono- and dihydroxycarboxylic acids, mono- and diaminocarboxylic acids, mono- and dihydroxysulphonic acids, mono- and diaminosulphonic acids and also mono- and dihydroxyphosphonic acids or mono- and diaminophosphonic acids and salts thereof such as dimethylolpropionic acid, dimethylolbutyric acid, hydroxypivalic acid, N-(2-aminoethyl)-β-alanine, 2-(2-aminoethylamino)ethanesulphonic acid, ethylenediaminepropyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and the alkali metal and/or ammonium salts thereof; the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and compounds which contain units which can be converted into cationic groups, amine-based units for example, such as N-methyldiethanolamine, as hydrophilic synthesis components. Additionally it is possible to use cyclohexylaminopropanesulphonic acid (CAPS) such as in WO-A 01/88006, for example, as a compound meeting the definition of component I.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potentially ionic groups, such as the salts of N-(2-aminoethyl)-β-alanine, of 2-(2-aminoethylamino)ethanesulphonic acid or of the adduct of IPDI and acrylic acid (EP-A 0 916 647, Example 1) and also of dimethylolpropionic acid.

Suitable nonionically hydrophilicizing compounds meeting the definition of component I.6) are, for example, polyoxyalkylene ethers containing at least one hydroxyl or amino group. These polyethers include a fraction of 30% to 100% by weight of units derived from ethylene oxide.

Nonionically hydrophilicizing compounds also include, for example, monohydric polyalkylene oxide polyether alcohols containing on average 5 to 70, preferably 7 to 55, ethylene oxide units per molecule, such as are obtainable in conventional manner by alkoxylating appropriate starter molecules (e.g. in Ullmanns Encyclopädie der technischen Chemie, 4th edition, volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine and also heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides suitable for the alkoxylation reaction are, in particular, ethylene oxide and propylene oxide, which may be used in any order or else as a mixture in the alkoxylation reaction.

The polyalkylene oxide polyether alcohols are either straight polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide units and not more than 60 mol % propylene oxide units.

For the PU polymers (I) it is preferred to use a combination of ionic and nonionic hydrophilicizing agents meeting the definitions of components I.5) and I.6). Particularly preferred combinations are those of nonionic and anionic hydrophilicizing agents.

Preference is given to using 5% to 45% by weight of component I.1), 50% to 90% by weight of component I.2), 1% to 30% by weight of the sum of compounds I.3) and I.4), not more than up to 12% by weight of component I.5), not more than up to 15% by weight of component I.6), the sum of I.5) and I.6) being 0.1% to 27% by weight and the sum of all of the components adding up to 100% by weight.

Particular preference is given to using 10% to 40% by weight of component I.1), 60% to 85% by weight of component I.2), 1% to 25% by weight of the sum of compounds I.3) and I.4), not more than up to 10% by weight of component I.5), not more than up to 10% by weight of component I.6), the sum of I.5) and I.6) being 0.1% to 20% by weight and the sum of all of the components adding up to 100% by weight.

Very particular preference is given to using 15% to 40% by weight of component I. 1), 60% to 82% by weight of component I.2), 1% to 20% by weight of the sum of compounds I.3), not more than up to 8% by weight of component I.5), not more than up to 10% by weight of component I.6), the sum of I.5) and I.6) being 0.1% to 18% by weight and the sum of all of the components adding up to 100% by weight.

The coating compositions of the invention comprise PU polymers (I) which are used in the form of their aqueous PU dispersion (I).

The process for preparing the aqueous PU dispersion (I) can be carried out in one or more stages in homogeneous phase or, in the case of multi-stage reaction, partly in disperse phase. Following partial or complete polyaddition of I. 1)-I.6), a dispersing, emulsifying or dissolving step takes place. This is followed optionally by a further polyaddition or modification in disperse phase.

For the preparation of the aqueous PU dispersions (I) it is possible to us all of the processes known from the prior art, such as prepolymer mixing processes, acetone processes or melt dispersing processes. The PU dispersion (I) is preferably prepared by the acetone process.

For preparing the PU dispersion (I) by the acetone process constituents I.2) to I.6), which should not contain any primary or secondary amino groups, and polyisocyanate component I.1) are typically included wholly or partly in the initial charge for preparing an isocyanate-functional polyurethane prepolymer, and are diluted if desired with a solvent which is miscible with water but inert with respect to isocyanate groups, and the optionally diluted mixture is heated to temperatures in the range from 50 to 120° C. The isocyanate addition reaction can be accelerated using the catalysts known in polyurethane chemistry. Dibutyltin dilaurate is preferred.

Suitable solvents are the typical aliphatic, keto-functional solvents such as acetone, butanone, which can be added not only at the beginning of the preparation but also, if desired, in portions later on as well. Acetone and butanone are preferred.

Subsequently the constituents of I. 1)-I.6) possibly not added at the beginning of the reaction are metered in.

In the preparation of the polyurethane prepolymer the molar ratio of isocyanate groups to isocyanate-reactive groups is I.0 to 3.5, preferably I.1 to 3.0, more preferably I.1 to 2.5.

The reaction of components I.1)- I.6) to form the prepolymer takes place partially or completely, but preferably completely. In this way polyurethane prepolymers are obtained which contain free isocyanate groups, in bulk (without solvent) or in solution.

The preparation of the polyurethane prepolymers is followed or accompanied, if it has not already been carried out in the starting molecules, by the complete or partial formation of salts of the anionically and/or cationically dispersing groups. In the case of anionic groups this is done using bases such as tertiary amines, examples being trialkylamines having 1 to 12, preferably 1 to 6, carbon atoms in each alkyl radical. Examples thereof are trimethylamine, triethylamine, methyldiethylamine, tripropylamine and diisopropylethylamine. The alkyl radicals may for example also carry hydroxyl groups, such as in the case of the dialkylmonoalkanolamines, alkyldialkanolamines and trialkanolamines. As neutralizing agents it is also possible optionally to use inorganic bases, such as ammonium or sodium hydroxide and/or potassium hydroxide. Preference is given to triethylamine, triethanolamine, dimethylethanolamine or diisopropylethylamine.

The molar amount of the bases is between 50% and 100%, preferably between 70% and 100%, of the molar amount of the anionic groups. In the case of cationic groups use is made of dimethyl sulphate or succinic acid. Where only nonionically hydrophilicized compounds I.6) with ether groups are used, the neutralization step is omitted. Neutralization may also take place simultaneously with dispersing, with the dispersing water already containing the neutralizing agent.

Subsequently, in a further step of the process, if it has not already taken place or has taken place only partially, the resulting prepolymer is dissolved with the aid of aliphatic ketones such as acetone or butanone.

Thereafter, possible NH₂-functional and/or NH-functional components are reacted with the remaining isocyanate groups. This chain extension/termination may be carried out either in solvent prior to dispersing, in the course of dispersing, or in water after the dispersing. The chain extension is preferably carried out prior to dispersing in water.

Where chain extension is carried out using compounds meeting the definition of I.5) and containing NH₂ or NH groups, the prepolymers are preferably chain extended prior to dispersing.

The degree of chain extension, in other words the equivalent ratio of NCO-reactive groups of the compounds used for chain extension to free NCO groups of the prepolymer, is between 40% to 150%, preferably between 70% to 120%, more preferably between 80% to 120%.

The aminic components [I.3), I.4), I.5)] can optionally be used in water- or solvent-diluted form in the process of the invention, individually or in mixtures, with any order of addition being possible in principle.

If water or organic solvents are used as diluents then the diluent content is preferably 70% to 95% by weight.

The preparation of the PU dispersion (1) from the prepolymers takes place following chain extension. For that purpose the dissolved and chain-extended polyurethane polymer is introduced into the dispersing water with strong shearing if appropriate, such as strong stirring, for example, or, conversely, the dispersing water is stirred into the prepolymer solutions. It is preferred to add the water to the dissolved prepolymer.

The solvent still present in the dispersions after the dispersing step is typically then removed by distillation. Removal even during dispersing is likewise possible.

Depending on the degree of neutralization and the amount of ionic groups it is possible to make the dispersion very fine, so that it almost has the appearance of a solution, although very coarse formulations are also possible, and are likewise sufficiently stable.

The solids content of the PU dispersion (I) is between 25% to 65%, preferably 30% to 60% and more preferably between 40% to 60%.

Additionally it is possible to modify the aqueous PU dispersions (I) by means of polyacrylates. For this purpose an emulsion polymerization of olefinically unsaturated monomers, examples being esters of (meth)acrylic acid and alcohols having 1 to 18 carbon atoms, styrene, vinyl esters or butadiene, is carried out in these polyurethane dispersions.

As component I.7) the PU dispersions (I) may comprise antioxidants and/or light stabilizers and/or other auxiliaries and additives.

As light stabilizers and antioxidants I.7) it is preferred to use sterically hindered phenols (phenolic antioxidants) and/or sterically hindered amines based on 2,2,6,6-tetramethylenepiperidine (Hindered Amine Light Stabilizers, HALS light stabilizers). Furthermore, it is possible for all of the auxiliaries and additives known for PU dispersions, such as emulsifiers, defoamers and thickeners, for example, to be present in the PU dispersions. Finally, in addition, fillers, plasticizers, pigments, carbon black sols and silica sols, aluminium dispersions, clay dispersions and asbestos dispersions may also be incorporated into the PU dispersions.

Crosslinkers II) used are water-dispersible or water-soluble, blocked polyisocyanates. The water-dispersible or water-soluble blocked polyisocyanates II) are synthesized from:
A) at least one polyisocyanate containing aliphatically, cycloaliphatically, araliphatically and/or aromatically attached isocyanate groups,
B) at least one ionic or potentially ionic and/or nonionic compound,
C) at least one blocking agent,
D) optionally one or more (cyclo)aliphatic monoamines and/or polyamines having 1 to 4 amino groups and a molecular weight in the range up to 300,
E) optionally one or more polyhydric alcohols having 1 to 4 hydroxyl groups and a molecular weight in the range up to 250 and
F) optionally stabilizers and other auxiliaries, and
G) optionally solvents.

The water-dispersible or water-soluble blocked polyisocyanates II) preferably contain 20% to 80% by weight of component A), 1% to 40% by weight of component B), 15% to 60% by weight of component C), 0 to 15% by weight of component D), 0 to 15% by weight of component E), 0 to 15% by weight of component F) and 0 to 20% by weight of component G), the sum of A to G) adding up to 100% by weight.

The water-dispersible or water-soluble blocked polyisocyanates II) more preferably contain 25% to 75% by weight of component A), 1% to 35% by weight of component B), 20% to 50% by weight of component C), 0 to 10% by weight of component D), 0 to 10% by weight of component E), 0 to 10% by weight of component F) and 0 to 15% by weight of component G), the sum of A to G) adding up to 100% by weight.

The water-dispersible or blocked polyisocyanates II) very preferably contain 30% to 70% by weight of component A), 5% to 30% by weight of component B), 25% to 45% by weight of component C), 0 to 5% by weight of component D), 0 to 5% by weight of component E), 0 to 5% by weight of component F) and 0 to 10% by weight of component G), the sum of A to G) adding up to 100% by weight.

The water-dispersible, blocked polyisocyanates II) can be used in the sizes of the invention as an aqueous solution or dispersion. The solution or dispersion of the polyisocyanates II) has a solids content of between 10% to 70%, preferably from 20% to 60% and more preferably from 25% to 50% by weight and the fraction of G) as a proportion of the overall composition is preferably less than 15% and more preferably less than 10% and very preferably less than 5% by weight.

The blocked polyisocyanates II) have an (average) NCO functionality of 2.0 to 5.0, preferably of 2.3 to 4.5, an isocyanate group (blocked and non-blocked) content of 5.0% to 27.0% by weight, preferably of 14.0% to 24.0% by weight, and a monomeric diisocyanate content of less than 1% by weight, preferably less than 0.5% by weight. The isocyanate groups of the polyisocyanates A) of the water-dispersible and/or water-soluble blocked polyisocyanates II) are at least 50%, preferably at least 60% and more preferably at least 70% in blocked form.

Suitable polyisocyanates A) are polyisocyanates synthesized from at least two diisocyanates and prepared by modifying simple aliphatic, cycloaliphatic, araliphatic and/or aromatic diisocyanates, said polyisocyanates having a uretdione, isocyanurate, allophanate, biuret, iminooxadiazinedione and/or oxadiazinetrione structure, of the kind described by way of example in, for example, J. Prakt. Chem. 336 (1994) page 185-200.

Suitable diisocyanates for preparing the polyisocyanates A) are those specified under component I.1).

The starting components A) are preferably polyisocyanates or polyisocyanate mixtures of the type stated containing exclusively aliphatically and/or cycloaliphatically attached isocyanate groups.

Particularly preferred starting components A) are polyisocyanates and/or polyisocyanate mixtures having an isocyanurate and/or biuret structure, based on HDI, IPDI and/or 4,4′-diisocyanatodicyclohexylmethane.

Suitable compounds for component B) are ionic or potentially ionic and/or nonionic compounds already described under component I.5) and I.6).

Preferred nonionic hydrophilicizing agents are polyalkylene oxide polyether alcohols which are either straight polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide units and not more than 60 mol % propylene oxide units.

Preferred ionic or potential ionic compounds B) are those which possess carboxyl or carboxylate and/or sulphonate groups and/or ammonium groups. Particularly preferred ionic compounds B) are those containing carboxyl and/or sulphonate groups as ionic or potentially ionic groups, such as the salts of N-(2-aminoethyl)-β-alanine, of 2-(2-aminoethylamino)ethanesulphonic acid, of the hydrophilicizing agent according to Example 1 of EP-A 0 916 647 and also of dimethylolpropionic acid.

Component B) is preferably a combination of nonionic and ionic hydrophilicizing agents. Particular preference is given to combinations of nonionic and anionic hydrophilicizing agents.

Blocking agents C) that may be mentioned include the following: alcohols, lactams, oximes, malonic esters, alkyl acetoacetates, triazoles, phenols, imidazoles, pyrazoles and also amines, such as butanone oxime, diisopropylamine, 1,2,4-triazole, dimethyl-1,2,4-triazole, imidazole, diethyl malonate, ethyl acetoacetate, acetone oxime, 3,5-dimethylpyrazole, C-caprolactam, N-methyl-, N-ethyl-, N-(iso)propyl-, N-n-butyl-, N-isobutyl-, N-tert-butyl-benzylamine or 1,1-dimethylbenzylamine, N-alkyl-N-1,1-dimethylmethylphenylamine, adducts of benzylamine with compounds having activated double bonds such as malonic esters, N,N-dimethylaminopropylbenzylamine and other optionally substituted, tertiary-amino-containing benzylamines and/or dibenzylamine, or any desired mixtures of these blocking agents. Preferred agents are ε-caprolactam, butanone oxime, N-tert-butylbenzylamine, diisopropylamine and 3,5-dimethylpyrazole. Particular preference is given to ε-caprolactam and butanone oxime.

Suitable components D) include mono-, di-, tri-, and/or tetra-amino-functional substances of the molecular weight range up to 300, such as ethylenediamine, 1,2- and 1,3-diaminopropane, 1,3-, 1,4- and 1,6-diaminohexane, 1,3-diamino-2,2-dimethylpropane, 1-amino-3,3,5-trimethyl-5-aminoethylcyclohexane (IPDA), 4,4′-diaminodicyclohexyhnethane, 2,4- and 2,6-diamino-1-methylcyclohexane, 4,4′-diamino-3,3′-dimethyldicyclohexylmethane, 1,4-bis(2-aminoprop-2-yl)cyclohexane or mixtures of these compounds.

Component E) comprises mono-, di-, tri- and/or tetra-hydroxy-functional substances of molecular weight up to 250, such as ethylene glycol, propylene glycol, 1,4-butanediol, 1,6-hexanediols, glycerol, trimethylolethane, trimethylolpropane, the isomeric hexanetriols, pentaerythritol or mixtures of these compounds.

The water-dispersible and/or water-soluble blocked polyisocyanates II) may optionally include a stabilizer or stabilizer mixture F). Examples of suitable compounds F) include antioxidants such as 2,6-di-tert-butyl-4-methylphenol, UV absorbers of the 2-hydroxyphenylbenzotriazole type or light stabilizers of the HALS compound type or other commercially customary stabilizers, as described for example in “Lichtschutzmittel für Lacke” (A. Valet, Vincentz Verlag, Hanover, 1996) and “Stabilization of Polymeric Materials” (H. Zweifel, Springer Verlag, Berlin, 1997, Appendix 3, pp. 181-213).

Suitable organic solvents G) are the paint solvents that are typical per se. Preferred solvents are acetone, 2-butanone, 1-methoxyprop-2-yl acetate, xylene, toluene, mixtures containing principally aromatics with relatively high degrees of substitution, such as are in commerce under the names Solvent Naphtha, Solvesso® (Exxon Chemicals, Houston, USA), Cypar® (Shell Chemicals, Eschborn, Del.), Cyclo Sole (Shell Chemicals, Eschborn, Del.), Tolu Sol® (Shell Chemicals, Eschborn, Del.), Shellsol® (Shell Chemicals, Eschborn, Del.), and also N-methylpyrrolidone. Particular preference is given to acetone, 2-butanone and N-methylpyrrolidone.

The water-dispersible blocked polyisocyanates II) can be prepared by known methods of the prior art (e.g. in DE-A 2 456 469, column 7-8, Example 1-5 and DE-A 2 853 937 pp. 21-26, Example 1-9).

For preparing the aqueous solution or dispersion containing the water-dispersible blocked polyisocyanate II) the general approach is to use amounts of water such that the resulting dispersions or solutions, respectively, have a solids content of 10 to 70%, preferably 20% to 60% and more preferably 25% to 50% by weight.

Examples of component III) are polyester polymers, polyurethanes, acrylic polymers, vinyl polymers such as polyvinyl acetate, polyurethane dispersions, polyacrylate dispersions, polyurethane-polyacrylate hybrid dispersions, polyvinyl ether and/or polyvinyl ester dispersions, polystyrene dispersions and/or polyacrylonitrile dispersions.

As component IV) auxiliaries and additives are added to the size compositions. These may be coupling agents, lubricants, antistats or else the coatings additives well known per se to the skilled person, such as dyes, pigments, flow control assistants, light stabilizers, ageing inhibitors and UV absorbers.

As coupling agents it is possible to use the known silane coupling agents such as 3-amino-propyltrimethoxy- and/or -triethoxysilane, N-(2-aminoethyl)-3-aminopropyltrimethoxysilane, 3-glycidylpropyltrimethoxysilane, vinyltrimethoxysilane, vinyltriethoxysilane or 3-methacryloyloxypropyltriethoxysilane. The concentration of the silane coupling agents in the size compositions of the invention is preferably 0.05% to 2% by weight, more preferably 0.15% to 0.85% by weight, based on the size composition as a whole.

The size compositions of the invention may further comprise one or more nonionic and/or ionic lubricants as part of component IV), such as polyalkylene glycol ethers of fatty alcohols or fatty amines, polyalkylene glycol ethers and glyceryl esters of fatty acids having 12 to 18 carbon atoms, polyalkylene glycols, higher fatty acid amides having 12 to 18 carbon atoms of polyalkylene glycols and/or alkyleneamines, quaternary nitrogen compounds, e.g. ethoxylated imidazolinium salts, mineral oils and waxes. The lubricants are employed preferably in a total concentration of 0.05% and 1.5% by weight, based on the size composition as a whole.

The size compositions of the invention may also comprise one or more antistats. Examples that may be mentioned include lithium chloride, ammonium chloride, Cr(III) salts, organotitanium compounds, arylalkyl sulphates or sulphonates, aryl polyglycol ether sulphonates or quaternary nitrogen compounds. The antistats are used preferably in concentrations of 0.01% to 0.8% by weight.

The size compositions may be prepared by the methods known per se. Preferably, water is charged to a suitable mixing vessel and, with stirring, the binder, the curing agent and then the lubricant and any further auxiliaries from component IV) are added. Thereafter the pH is adjusted to 5-7 and a hydrolysate of a coupling agent from component IV) is added. After a further stirring time of 15 minutes the size composition is ready to be used and can be applied following pH adjustment where appropriate.

The size compositions can be applied to a suitable substrate by any desired methods, such as by means of spray applicators or roll applicators, for example, and cured.

Glass types suitable for the sized glass fibres include not only the known glass types used for fibre glass manufacture, such as E, A, C and S glass in accordance with DIN 1259-1, but also the other, conventional products of the glass fibre producers. Among the types of glass mentioned, the E glass fibres possess the greatest importance for the production of continuous glass fibres, for the reinforcement of plastics, owing to their freedom from alkali, their high tensile strength and their high modulus of elasticity.

The process of producing, the process of sizing and the subsequent processing of the glass fibres is known and is described for example in K. L. Loewenstein “The Manufacturing Technology of Continous Glass Fibres”, Elsevier Scientific Publishing Corp., Amsterdam, London, N.Y., 1983.

### EXAMPLES

Unless indicated otherwise all percentages are to be understood as weight percentages.

Substances and abbreviations used:
Diaminosulphonate: NH₂—CH₂CH₂—NH—CH₂CH₂—SO₃Na (45% strength in water)
Desmophen® 2020: Polycarbonate polyol, OH number 56 mg KOH/g, number-average molecular weight 2000 g/mol (Bayer AG, Leverkusen, DE)
PolyTHF® 2000: Polytetramethylene glycol polyol, OH number 56 mg KOH/g, number-average molecular weight 2000 g/mol (BASF AG, Ludwigshafen, DE)
PolyTHF® 1000: Polytetramethylene glycol polyol, OH number 112 mg KOH/g, number-average molecular weight 1000 g/mol (BASF AG, Ludwigshafen, DE)
Polyether LB 25: (monofunctional polyether based on ethylene oxide/propylene oxide, number-average molecular weight 2250 g/mol, OH number 25 mg KOH/g (Bayer AG, Leverkusen, DE)
KV 1386 40% strength aqueous solution of the Na salt of N-(2-aminoethyl)-β-alanine (BASF AG, Ludwigshafen, DE)

The solids contents were determined in accordance with DIN-EN ISO 3251.

Unless expressly mentioned otherwise, NCO contents were determined volumetrically in accordance with DIN-EN ISO 11909.

Crosslinker Dispersion (Component II):

147.4 g of a polyisocyanate containing biuret groups, based on 1,6-diisocyanatohexane (HDI) and having an NCO content of 23.0% were stirred with 39.2 g of Polyether LB 25 (monofunctional polyether based on ethylene oxide/propylene oxide, number-average molecular weight 2250 g/mol, OH number 25 mg KOH/g, Bayer AG, Leverkusen, DE) at 100° C. for 30 minutes. Subsequently, over the course of 20 minutes, 493.0 g of caprolactam were added with stirring at a rate such that the temperature of the mixture did not exceed 110° C. The mixture was stirred at 110° C. until the theoretical NCO value was reached. Thereafter it was cooled to 90° C. and over the course of 2 minutes a mixture of 152.5 of the hydrophilicizing agent KV 1386 (BASF AG, Ludwigshafen, DE) and 235.0 g of water was metered in. That was followed by dispersing, by the addition of 3325.1 g of water. Subsequent stirring for a time of 2 h gave a storage-stable aqueous dispersion having a solids content of 30.0%.

### Example 1

### Comparative Example PU Dispersion (Component I)

1530.0 g of a difunctional polyester polyol based on adipic acid and hexanediol (average molecular weight 1700 g/mol, OHN=about 66 mg KOH/g substance) and 67.50 g were heated to 65° C. Subsequently at 65° C., over the course of 5 minutes, 455.1 g of isophorone diisocyanate were added and the mixture was stirred at 100° C. until the theoretical NCO value of 4.6% was reached. The finished prepolymer was dissolved with 2781 g of acetone at 50° C. and then a solution of 139.1 g of isophoronediamine and 247.2 g of acetone was metered in over the course of 10 minutes. Subsequently a solution of 46.0 g of diaminosulphonate, 4.80 of hydrazine hydrate and 239.1 g of water was metered in over the course of 5 minutes. The subsequent stirring time was 15 minutes. This was followed by dispersing over the course of 10 minutes, by addition of 3057 g of water. The removal of the solvent by vacuum distillation followed that, to give a storage-stable PU dispersion having a solids content of 40.1% and a particle size of 207 nm.

### Example 2

### PU Dispersion (Component I)

144.5 g of Desmophen® 2020, 188.3 g of PolyTHF® 2000, 71.3 g of PolyTHF® 1000 and 13.5 g of polyether LB 25 were heated to 70° C. Subsequently at 70° C., over the course of 5 minutes, a mixture of 59.8 g of hexamethylene diisocyanate and 45.2 g of isophorone diisocyanate was added and the mixture was stirred at reflux until the theoretical NCO value was reached. The finished prepolymer was dissolved with 1040 g of acetone at 50° C. and then a solution of 1.8 g of hydrazine hydrate, 9.18 g of diaminosulphonate and 41.9 g of water was metered in over the course of 10 minutes. The subsequent stirring time was 10 minutes. Following the addition of a solution of 21.3 g of isophoronediamine and 106.8 g of water, dispersing was carried out over the course of 10 minutes by addition of 395 g of water. The removal of the solvent by vacuum distillation followed that, to give a storage-stable dispersion having a solids content of 50.0%.

### APPLICATION EXAMPLES

Table 1 shows the size compositions in detail. The compositions were prepared as follows: a mixing vessel was charged with half the indicated amount of water and, in succession and with stirring, the inventive PU dispersions, film-forming resins, crosslinker dispersion and lubricant (Breoxe® 50-A 140, BP-Chemicals, GB) were added. Thereafter the pH was adjusted with acetic acid to 5-7 and a hydrolysate, prepared according to the manufacturer's instructions, of 3-aminopropyltriethoxysilane (A1100, UCC, New York, USA) was added as an aqueous coupling agent solution. After a further stirring time of 15 minutes the size was ready to use.

Subsequently, following adjustment of the pH to 5-7 where appropriate, the size compositions were applied to glass fibres. The glass fibres thus sized were subsequently chopped and dried.

| | Size 1 | Size 2 | Size 3 | | |
|---|---|---|---|---|---|
| | comparative | comparative | comparative | Size 4 | Size 5 |
| Water | 42.0 kg | 42.0 kg | 44.3 kg | 44.3 kg | 44.3 kg |
| PU dispersion | 11.5 kg | 11.5 kg | 9.2 kg | 9.2 kg | 9.2 kg |
| | Example 1 | Example 1 | Example 1 | Example 2 | Example 2 |
| Crosslinker dispersion | 1.5 kg | 3.0 kg | 0 kg | 1.5 kg | 3.0 kg |
| Coupling agent | 0.6 kg | 0.6 kg | 0.6 kg | 0.6 kg | 0.6 kg |
| Lubricant | 0.4 kg | 0.4 kg | 0.4 kg | 0.4 kg | 0.4 kg |
| Water | 44.0 kg | 42.5 kg | 45.5 kg | 44.0 kg | 42.5 kg |
| Total | 100.0 kg | 100.0 kg | 100.0 kg | 100.0 kg | 100.0 kg |
| | The glass fibres produced with the respective sizes, chopped and | | | | |
| | dried were compounded into PA 6 (proportion: 30%) and the | | | | |
| | following physical properties were determined | | | | |
| Tensile strength | 187 | 188 | 187 | 189 | 187 |
| Flexural strength | 184 | 185 | 185 | 186 | 185 |
| Impact strength before | 74 | 78 | 77 | 82 | 82 |
| glycol storage | | | | | |
| Impact strength after | 38 | 40 | 41 | 45 | 46 |
| glycol storage* | | | | | |
| Impact strength after | 43 | 41 | 47 | 68 | 74 |
| storage under | | | | | |
| hydrolysis conditions** | | | | | |

150 h storage at 135° C./2 bar in glycol/water 1/1
**10 weeks at 70° C., 95% atmospheric humidity

The impact strengths found after storage in glycol/water demonstrate that the glass fibres sized with the size compositions of the invention exhibit a significantly reduced drop in impact strength values and hence are substantially more stable to hydrolysis and glycolysis.

What is claimed is:

1. Size compositions comprising:
(I) one or more aqueous polyurethane-polyurea polymers (PU polymers) synthesized from compounds selected from the group consisting of
I.1) polyisocyanates,
I.2) mixture of polycarbonate polyols and polytetramethylene glycol polyols having number-average molecular weights of 200 to 8000 g/mol,
I.3) compounds of molecular weight 62 to 400 possessing in total two or more hydroxyl and/or amino groups,
I.4) compounds possessing a hydroxyl or amino group,
I.5) isocyanate-reactive, ionically or potentially ionically hydrophilicizing compounds,
I.6) isocyanate-reactive nonionically hydrophilicizing compounds, and
(II) water-dispersible, blocked polyisocyanates at least 50% of whose isocyanate groups are blocked,
(III) optionally further polymers soluble, emulsifiable or dispersible in water, and
(IV) auxiliaries and additives selected from the group consisting of coupling agents, lubricants, antistats, dyes, pigments, flow control agents, light stabilizers, ageing inhibitors or UV absorbers.

2. Size composition according to claim 1, wherein the polyurethane-polyurea polymers (I) comprise a mixture of polycarbonate polyols and polytetramethylene glycol polyols, the fraction of the polycarbonate polyols in the mixture being between 20% and 80% by weight and the fraction of polytetramethylene glycol polyols being between 80% and 20% by weight.

3. Size composition according to claim 1, wherein the polyurethane-polyurea polymers (I) comprise a combination of components I.5) and I.6).

4. Process for preparing the size compositions according to claim 1, the process comprising the steps of i) charging a mixing vessel with water; ii) adding, with stirring, the binder (I), the curing agent (II) and subsequently the lubricant (IV) and optionally further auxiliaries from component IV); and iii) adjusting the pH (20° C.) to 5 to 7 and adding a hydrolysate of a coupling agent from component (IV).

5. Glass fibre coated with size composition according to claim 1.

6. Carbon fibre coated with size composition according to claim 1.
